(19) United States
(12) Patent Application Publication
(10) Pub. No.: US 2019/0246830 A1
(43) Pub. Date: Aug. 15, 2019

(54) APPLIANCE FOR STEAMING FOOD

(71) Applicants: Jallis Ametepe, Bellevue, NE (US); Cassandra Aristhyl, Bellevue, NE (US)

(72) Inventors: Jallis Ametepe, Bellevue, NE (US); Cassandra Aristhyl, Bellevue, NE (US)

(21) Appl. No.: 16/275,298

(22) Filed: Feb. 13, 2019

Related U.S. Application Data
(60) Provisional application No. 62/630,091, filed on Feb. 13, 2018.

(51) Int. Cl. A47J 27/00; A47J 27/04; A47J 36/32; A47J 36/06

(52) U.S. Cl. CPC A47J 27/004; A47J 27/04; A47J 2027/043; A47J 36/06; A47J 36/32

(57) ABSTRACT

An appliance for steaming food is an electric, programmable food steamer for cooking food, having a coil heating element in the bottom portion, a water tray that is at least partially removable from the side for refilling, a divided food container that slides in from the top, a top cover, and a control panel on the outer sidewall for programming at least the settings for various start and end times and cook durations.

### CROSS-REFERENCE TO RELATED APPLICATION

The present application is related to and claims priority from prior provisional application Ser. No. 62/630,091, filed Feb. 13, 2018 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of cooking appliances and more specifically relates to an appliance for steaming food.

### 2. Description of the Related Art

The preparation of food has become an increasingly popular topic in the last twenty five years or so because of public awareness of the connection between the lack of nutrition and vitamin/mineral deficiency diseases. There are more television shows on cooking not only delicious meals but meals that are high in nutrition and meals that maintain the nutrition that the foods inherently have before the cooking or preparation process begins. A common method of cooking most foods involves using cooking oils to cook the food from the outside toward the inside. The foods always absorb some of the oil and sometimes even become saturated with the oil if the person cooking is not well versed on the cook/fry time and level of heat needed for particular foods. In the very best case, oil is still absorbed into the food. Placing the food on a non-coated paper plate in a warm environment will often reveal how much oil the food has absorbed.

The problem with most cooking oils is that the molecular structure of the oil is changed at higher temperatures and the resulting product is considered to be harmful to the consumer's health. In addition to this problem, many of the oils used that are high in saturated and trans fats are also high in erucic acid, a substance known to be toxic, and these oils are considered unhealthy even before heating to a high temperature. Most consumers either do not have or do not take the time to try to become educated in this regard because of the confusion stemming from contradictory information that comes from experts. For instance, experts often disagree as to which oils are healthy and which oils are harmful, but add to this that even healthy oils easily often become unhealthy when used by a non-expert cook. A solution to the problem is needed.

Ideally, a cooking appliance should provide cooking of food without the necessity of constant oversight by the preparer while avoiding the introduction of harmful constituents into the food, and yet, would operate reliably and be manufactured at a modest expense. Thus, a need exists for a reliable appliance for steaming food to avoid the above-mentioned problems.

### BRIEF SUMMARY OF THE INVENTION

In view of the foregoing disadvantages inherent in the known cooking appliances art, the present invention provides a novel appliance for steaming food. The general purpose of the present invention, which will be described subsequently in greater detail, is to provide the cooking of food without the necessity of constant oversight by the preparer while avoiding the introduction of harmful constituents into the food.

In a preferred embodiment, the cooking appliance preferably comprises a generally cylindrical housing having a substantially flat bottom, a substantially round wall, and two handles disposed diametrically opposite to each other on the outside of the wall near the top of the housing, a control unit disposed in the wall of the housing to control operation of the cooking appliance, a heating element disposed on the inside of the bottom of the housing and connected to the control unit in order to respond to instructions from the control unit, a power source connector for connecting to an exterior power source to power at least the control unit and the heating element, a drawer disposed above the heating element and near the bottom of the housing for containing a liquid with the drawer including a pullout handle to facilitate at least partial removal of the drawer from the housing, a fully removable generally cylindrical open top container sized to fit entirely within the housing and above the removable drawer of the housing for holding one or more heatable units, with the container having two handles disposed diametrically opposite to each other along outer top edges of the container and with the handles of the container being sized to function as stops with respect to the wall of the housing so the container is positioned above the removable drawer of the housing when the container is fully lowered into the housing, a removable generally round lid for covering the open top container and with the lid including at least a lid handle and at least a steam hole, and the control unit having a control panel to allow a user to at least turn on the cooking appliance, which results in the heating element heating the liquid in the drawer so the liquid at least partially changes to steam which rises from the drawer to heat the container holding the one or more heatable units, and to heat the one or more heatable units. The cooking appliance further comprises a solar power source for powering the control unit and the heating element. The control panel of the control unit allows the user to turn off the cooking appliance and to specify a length of time for heating the heatable elements. The control unit halts the heating of the heating element when the liquid has substantially evaporated from the drawer. The container for holding the one or more heatable units comprises a mesh material at least in part and at least a vertical divider to divide the interior of the container into separate parts with each part available to hold a respectively different heatable unit.

A food steamer preferably comprises a base having a bottom attached to a wall around the bottom, a controller disposed in the base for controlling operation of the food steamer, a heating unit disposed adjacent to the bottom of the base and connected to the controller for responding to one or more instructions from the controller, a solar power unit to power at least the controller and the heating unit, a liquid container disposed above the heating unit for containing a liquid and releasing steam from the liquid when the liquid is heated sufficiently by the heating unit, an open topped food container for containing food and sized to fit entirely within the base above the liquid container, a lid for covering at least the food container, and the controller having a user interface to allow a user to operate the food steamer. The food steamer further comprises a connector to connect the food steamer to an exterior power source to power at least the controller and the heating unit. The open topped food container may also comprise mesh material that is fully removable from the base and the liquid container is preferably at least partially removable from the base to facilitate adding liquid.

The appliance for steaming food may comprise a case including one or more heating elements, a liquid holder for holding a liquid and allowing steam from the liquid to escape upward when the liquid is heated by the one or more heating elements, a food container for containing food above the liquid holder so escaping steam heats the food, a solar power unit to selectively power the one or more heating units, and a lid for covering at least the food container. The appliance for steaming food further comprises a connector to connect the appliance to an external power source to power the heating unit. The food container may comprise mesh and is at least partially removable from the case. The case comprises at least a stop on the interior of the case for holding the food container above the liquid holder and the liquid holder is at least partially removable from the case to facilitate adding liquid. A controller is also disposed in the case for controlling operation of the appliance and the controller comprises a user interface to receive user input related to the operation of the appliance.

The present invention holds significant improvements and serves as an appliance for steaming food. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an appliance for steaming food, constructed and operative according to the teachings of the present invention.

FIG. 1 shows a perspective view illustrating a cooking appliance according to an embodiment of the present invention.

FIG. 2 is a perspective view illustrating the cooking appliance 100 according to an embodiment of the present invention of FIG. 1.

FIG. 3 is a perspective view illustrating food steamer according to an embodiment of the present invention.

FIG. 4 is a perspective view illustrating the food steamer according to an embodiment of the present invention of FIG. 3.

FIG. 5 a perspective view illustrating an appliance for steaming food according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a cooking appliance and more particularly to an appliance for steaming food as used to improve the convenience of cooking food without adding harmful constituents into the food.

Generally speaking, an appliance for steaming food is an electric, programmable food steamer for cooking food, having a coil heating element in the bottom portion, a water tray that is at least partially removable from the side for refilling, a divided food container that slides in from the top, a top cover, and a control panel on the outer sidewall for programming at least the settings for various start and end times and cook durations. An option may include the water container being sealed in. The solid container which allow the user to use the cooking appliance as a mini oven and or a pot. The present invention may also be used to warm food.

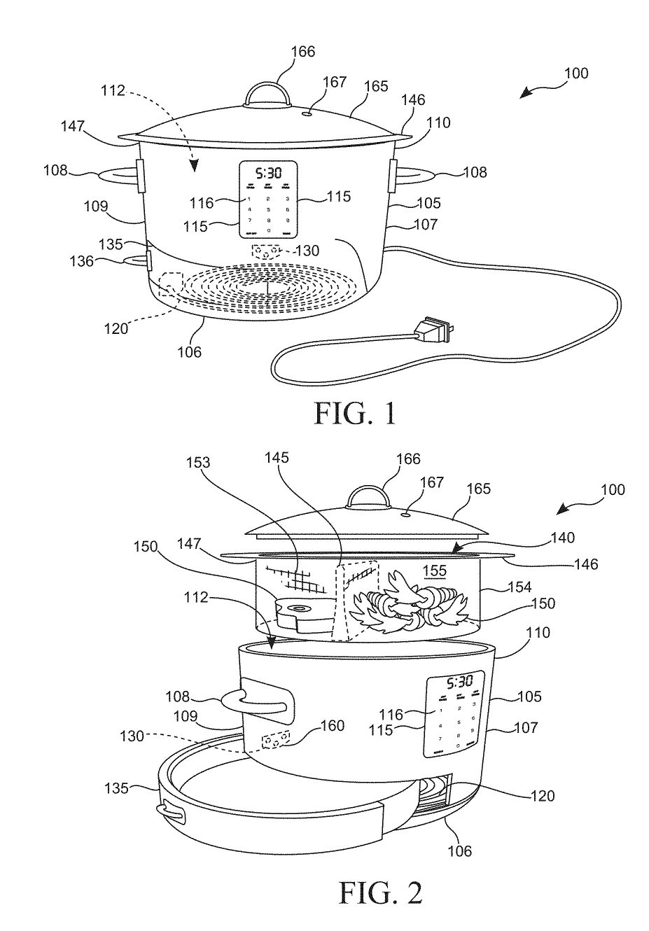

Referring to the drawings by numerals of reference there is shown in FIG. 1, a perspective view illustrating cooking appliance 100 according to an embodiment of the present invention.

In a preferred embodiment, cooking appliance 100 preferably comprises a generally cylindrical housing 105 having a substantially flat bottom 106, a substantially round wall 107, and two handle(s) 108 disposed diametrically opposite to each other on outside 109 of wall 107 near top 110 of housing 105, control unit 115 disposed in the wall 107 of housing 105 to control operation of cooking appliance 100, heating element 120 disposed on inside 112 of bottom 106 of housing 105 and connected to control unit 115 in order to respond to instructions from control unit 115, power source connector 130 for connecting to an exterior power source to power at least control unit 115 and heating element 120, and drawer 135 disposed above heating element 120 and near bottom 106 of housing 105 for containing a liquid with drawer 135 including pullout handle 136 to facilitate at least partial removal of drawer 135 from housing 105.

Referring now to FIG. 2, is a perspective view illustrating cooking appliance 100 according to an embodiment of the present invention of FIG. 1.

A fully removable generally cylindrical open top container 145 is sized to fit entirely within housing 105 and above the removable drawer 135 of housing 105 for holding one or more heatable units 150, with open top container 145 having two handle(s) 152 disposed diametrically opposite to each other along outer top edges 147 of open top container 145 and with handles 146 of open top container 145 being sized to function as stops with respect to wall 107 of housing 105 so open top container 145 is positioned above removable drawer 135 of housing 105 when open top container 145 is fully lowered into housing 105.

A removable generally round lid 165 for covering open top container 145 is included and includes at least lid handle 166 and at least steam hole 167, and control unit 115 has control panel 116 to allow a user to at least turn on cooking appliance 100 which results in heating element 120 heating the liquid in removable drawer 135 so the liquid at least partially changes to steam which rises from removable drawer 135 to heat open top container 145 holding and heating the one or more heatable units 150. Cooking appliance 100 may further comprise solar power source 160 for powering control unit 115 and heating element 120. Control panel 116 of control unit 115 allows the user to turn off cooking appliance 100 and to specify a length of time for heating heatable units 150. Control unit 115 halts the heating of heating element 120 when the liquid has substantially evaporated from removable drawer 135. Open top container 145 for holding the one or more heatable units 150 comprises mesh material 153 at least in part and at least vertical divider 154 to divide interior 155 of open top container 145 into separate parts with each part available to hold a respectively different heatable units 150.

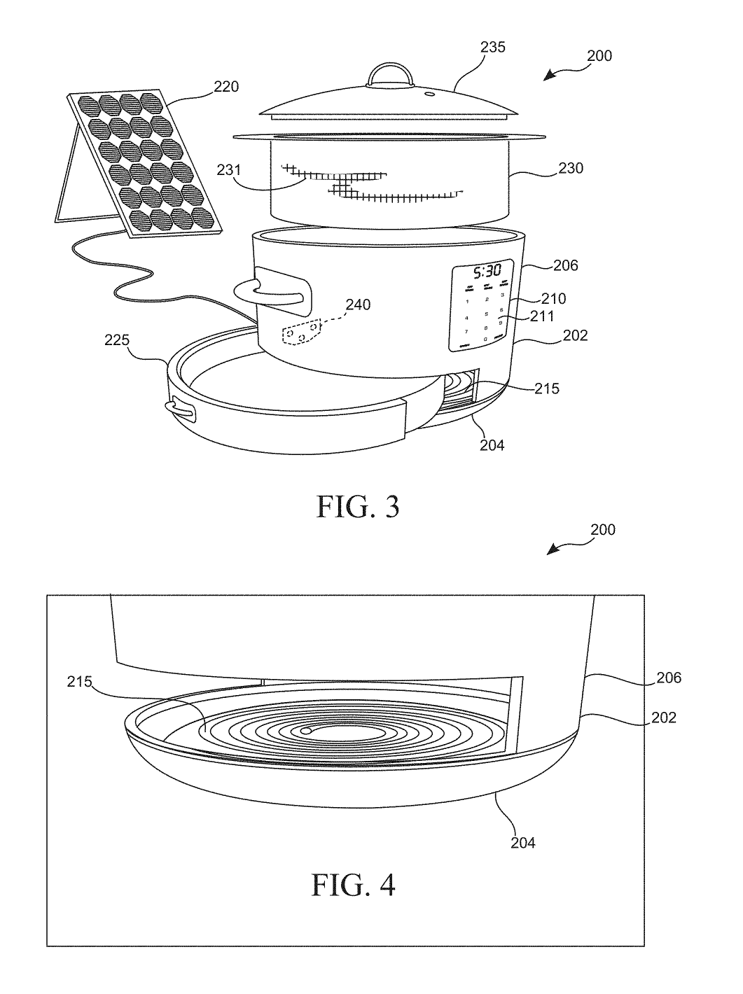

Referring now to FIG. 3, is a perspective view illustrating food steamer 200 according to an embodiment of the present invention of FIG. 1.

Food steamer 200 preferably comprises base 202 having bottom 204 attached to wall 206 around bottom 204, controller 210 disposed in base 202 for controlling operation of food steamer 200, heating unit 215 disposed adjacent to bottom 204 of bottom 204 and connected to controller 210 for responding to one or more instructions from controller 210, solar power unit 220 to power at least controller 210 heating unit 215, and liquid container 225 disposed above heating unit 215 for containing a liquid and releasing steam from the liquid when the liquid is heated sufficiently by heating unit 215.

Referring now to FIG. 4, showing is a perspective view illustrating food steamer 200 according to an embodiment of the present invention of FIG. 1.

An open topped food container 230 for containing food is sized to fit entirely within base 202 above liquid container 225 and lid 235 is included for covering at least food container 230. Controller 210 having user interface 211 allows a user to operate food steamer 200. Food steamer 200 further comprises connector 240 to connect food steamer 200 to an exterior power source to power at least controller 210 and heating unit 215. The open topped food container 230 may also comprise mesh material 231 that is fully removable from base 202 and liquid container 225 is preferably at least partially removable from base 202 to facilitate adding liquid.

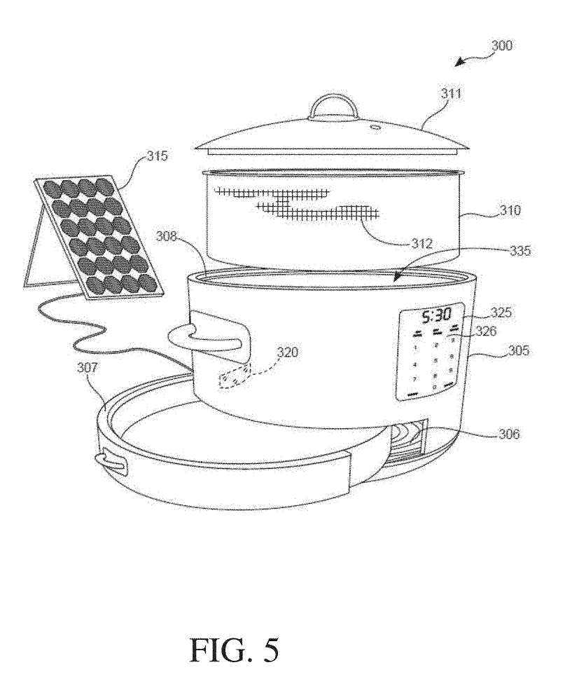

Referring now to FIG. 5, a perspective view illustrating appliance for steaming food 300 according to an embodiment of the present invention of FIG. 1.

Appliance for steaming food 300 may comprise case 305 including one or more heating elements 306, liquid holder 307 for holding a liquid and allowing steam from the liquid to escape upward when the liquid is heated by the one or more heating elements 306, food container 310 for containing food above liquid holder 307 so escaping steam heats the food, solar power unit 315 to selectively power the one or more heating elements 306, and lid 311 for covering at least food container 310. Appliance for steaming food 300 further comprises connector 320 to connect appliance for steaming food 300 to an external power source to power heating elements 306. Food container 310 may comprise mesh 312 and is at least partially removable from case 305. Case 305 comprises at least stop 330 on interior 335 of case 305 for holding food container 310 above liquid holder 307 and liquid holder 307 is at least partially removable from case 305 to facilitate adding liquid. Controller 325 is also disposed in case 305 for controlling operation of appliance for steaming food 300 and controller 325 comprises user interface 326 to receive user input related to the operation of appliance for steaming food 300.

Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A cooking appliance, comprising:
a generally cylindrical housing having a substantially flat bottom, a substantially round wall, and two handles disposed diametrically opposite to each other on the outside of the wall near the top of the housing;
a control unit disposed in the wall of the housing to control operation of the cooking appliance;
a heating element disposed on the inside of the bottom of the housing and connected to the control unit in order to respond to instructions from the control unit;
a power source connector for connecting to an exterior power source to power at least the control unit and the heating element;
a drawer disposed above the heating element and near the bottom of the housing for containing a liquid with the drawer including a pullout handle to facilitate at least partial removal of the drawer from the housing;
a fully removable generally cylindrical open top container sized to fit entirely within the housing and above the removable drawer of the housing for holding one or more heatable units,
with the container having two handles disposed diametrically opposite to each other along outer top edges of the container, and
with the handles of the container being sized to function as stops with respect to the wall of the housing so the container is positioned above the removable drawer of the housing when the container is fully lowered into the housing;
a removable generally round lid for covering the open top container and with the lid including at least a lid handle and at least a steam hole; and
the control unit having a control panel to allow a user to at least turn on the cooking appliance, which results in the heating element heating the liquid in the drawer so the liquid at least partially changes to steam, which rises from the drawer to heat the container holding the one or more heatable units, and to heat the one or more heatable units.

2. The cooking appliance of claim 1, further comprising a solar power source for powering the control unit and the heating element.

3. The cooking appliance of claim 1, wherein the control panel of the control unit allows the user to turn off the cooking appliance.

4. The cooking appliance of claim 1, wherein the control panel of the control unit allows the user to specify a length of time for heating the heating elements.

5. The cooking appliance of claim 1, wherein the control unit halts the heating of the heating element when the liquid has substantially evaporated from the drawer.

6. The cooking appliance of claim 1, wherein the container for holding the one or more heatable units comprises a mesh material at least in part.

7. The cooking appliance of claim 1, wherein the container for holding the one or more heatable units comprises at least a vertical divider to divide the interior of the container into separate parts with each part available to hold a respectively different heatable unit.

8. A food steamer, comprising:
a base having a bottom attached to a wall around the bottom;
a controller disposed in the base for controlling operation of the food steamer;
a heating unit disposed adjacent to the bottom of the base and connected to the controller for responding to one or more instructions from the controller;
a solar power unit to power at least the controller and the heating unit;
a liquid container disposed above the heating unit for containing a liquid and releasing steam from the liquid when the liquid is heated sufficiently by the heating unit;
an open topped food container for containing food and sized to fit entirely within the base above the liquid container;
a lid for covering at least the food container; and
the controller having a user interface to allow a user to operate the food steamer.

9. The food steamer of claim 8, further comprising a connector to connect the food steamer to an exterior power source to power at least the controller and the heating unit.

10. The food steamer of claim 8, wherein the open topped food container comprises mesh material.

11. The food steamer of claim 8, wherein the open topped food container is fully removable from the base.

12. The food steamer of claim 8, wherein the liquid container is at least partially removable from the base to facilitate adding liquid.

13. An appliance for steaming food, comprising:
a case including one or more heating elements;
a liquid holder for holding a liquid and allowing steam from the liquid to escape upward when the liquid is heated by the one or more heating elements;
a food container for containing food above the liquid holder so escaping steam heats the food;
a solar power unit to selectively power the one or more heating units; and
a lid for covering at least the food container.

14. The appliance for steaming food of claim 13, further comprising a connector to connect the appliance to an external power source to power the heating unit.

15. The appliance for steaming food of claim 13, wherein the food container comprises mesh.

16. The appliance for steaming food of claim 13, wherein the food container is at least partially removable from the case.

17. The appliance for steaming food of claim 13, wherein the case comprises at least a stop on the interior of the case for holding the food container above the liquid holder.

18. The appliance for steaming food of claim 13, wherein the liquid holder is at least partially removable from the case to facilitate adding liquid.

19. The appliance for steaming food of claim 13, further comprising a controller disposed in the case for controlling operation of the appliance.

20. The appliance for steaming food of claim 18, wherein the controller comprises a user interface to receive user input related to the operation of the appliance.
